(19) United States
(12) Patent Application Publication
(10) Pub. No.: US 2017/0044031 A1
(43) Pub. Date: Feb. 16, 2017

(54) A METHOD FOR HARMLESS DISPOSAL AND RESOURCE UTILIZATION OF RESIN DESORPTION LIQUID GENERATED IN THE ION EXCHANGE PROCESS

(71) Applicant: NANJING UNIVERSITY, Nanjing, Jiangsu (CN)

(72) Inventors: AIMIN J. LI, NANJING (CN); BOJUN WANG, NANJING (CN); CHANGMING WANG, NANJING (CN); YELI JIANG, NANJING (CN); ZHAOLIAN ZHU, NANJING (CN); HAIOU SONG, NANJING (CN); JUN WANG, NANJING (CN); XUN CHEN, NANJING (CN)

(21) Appl. No.: 15/305,429

(22) PCT Filed: Nov. 7, 2014
(86) PCT No.: PCT/CN2014/090598

§ 371 Date: Oct. 20, 2016

(30) Foreign Application Priority Data
Apr. 30, 2014 (CN) 201410182024.3

(51) Int. Cl. C02F 1/467; C02F 1/461; B01J 41/00

(52) U.S. Cl. CPC C02F 1/4672; B01J 41/00; C02F 1/46109; C02F 2001/46142; C02F 2201/46115

(57) ABSTRACT

A method for harmless disposal and resource utilization of resin desorption liquid generated in the ion exchange process is provided. Resin desorption liquid is channeled into an electrolytic tank, which is arranged with an inlet and an outlet; the anode and the cathode within the electrolytic tank are separately connected to a stabilized power supply; both the direct and indirect oxidation process and occurred at the anode can decompose the organic pollutants in the desorption liquid; with necessary replenishment of fresh regeneration agent, the treated desorption liquid can exert excellent performance in regenerating saturated resin; the recycled use of resin desorption liquid is therefore realized, which consequently avoids unnecessary waste of regeneration agent and reduces the final yield of the desorption liquid. This method is characterized by being convenient in operation, without addition of extra reagents, without secondary pollution, and suitable for the desorption liquid with wide pH variations.

### CROSS-REFERENCE TO RELATED APPLICATIONS

This application claims priority to PCT Application No. PCT/CN2014/090598, having a filing date of Nov. 7, 2014, based off of Chinese Application No. 201410182024.3, having a filing date of Apr. 30, 2014, the entire contents of which are hereby incorporated by reference.

### FIELD OF TECHNOLOGY

The following relates to a method for harmless disposal and resource utilization of resin desorption liquid generated in the ion exchange process, specifically to a method for harmless disposal and resource utilization of resin desorption liquid generated in the anion exchange process adopted for advanced treatment of biotreated effluent.

### BACKGROUND

China is a country short of water resources, with per capita water availability being only one-fourth of the global average, and to make matters worse, the water resources in China are notoriously unevenly distributed and poorly utilized. With rapid development of economy and society, demand for water keeps increasing constantly, which further highlights the great conflict between water shortage and social development. In order to deal with aggravating water shortage in China, it is very necessary to implement advanced wastewater treatment and reuse of reclaimed water.

Advanced treatment methods include physical processes such as filtration, adsorption, membrane separation and evaporation concentration, chemical processes such as ion exchange, coagulation and advanced oxidation, and biological processes such as biological nitrogen removal, dephosphorization.

Among them, ion exchange is an advanced treatment method widely used in the wastewater treatment field. This method, by utilizing ion exchange resin to filter the raw water, can realize ion exchange between the ions contained in the water and those fixed on the resin. As most of organic pollutants in biotreated effluent carry the negative surface charge, the anion exchange resin is more widely used.

NDMP resin is a new type of magnetic anion exchange resin with an acrylic matrix independently invented by Nanjing University, characterized by small particle size, quick adsorption performance, high precipitability and easy regenerability. It can not only adsorb organic pollutants in the water and consequently greatly reduce the level of COD and UV₂₅₄ therein, but also eliminate salt ions such as the nitrate ion, the fluoride ion and the sulfate ion in the water. In comparison with other processes for advanced wastewater treatment, the ion exchange method presents many advantages, such as desirable treatment effect, low operating cost and convenient operation procedure. However, the ion exchange process will produce a small quantity of resin desorption liquid, which is characterized by high salinity, high concentration, complex composition, high toxicity, poor biodegradability and high chromaticity. Therefore, indiscreet disposal of the desorption liquid may cause secondary pollution, and as the desorption liquid contains a large share of resin regeneration agent, indiscreet disposal of it leads to unnecessary waste of resources as well.

Conventional disposal methods of desorption liquid include solidification and burial, evaporation/concentration and incineration, enhanced coagulation, membrane filtration and advanced oxidation. Among them, the solidification and burial method merely relocates the pollutant, and its requires land to serve as the burial ground; the evaporation/concentration and incineration method can dispose of the desorption liquid thoroughly, but it is characterized by large energy consumption and high cost; the enhanced coagulation method requires a large quantity of reagents, which consequently causes a high yield of sludge and make the treated liquid difficult to reach quality standards directly; the membrane filtration method is likely to cause contamination of the membrane, and other steps are required for further treatment of the filtered liquid; The advanced oxidation method includes ozone oxidation, Fenton oxidation, electrocatalytic oxidation, and etc.; Ozone oxidation leaves no secondary pollution, but it is characterized by low efficiency in ozone utilization and high electricity consumption; Fenton oxidation enjoys such advantages as being simple in reaction procedures and convenient in control, but it also has many disadvantages such as being inconvenient in storing and transporting liquid hydrogen peroxide, and comparatively costly.

Electrocatalytic oxidation has been showing unique advantages in the wastewater treatment field, such as high environmental compatibility, simple structure of the electrochemical system and therefore small occupation space, low cost of operation and maintenance, rare secondary pollution, high controllability of reaction procedure and easiness to realize automatic operation. Therefore, the electrochemical technique whereon electrocatalytic oxidation is based is regarded as an environment-friendly method that can effectively solve water pollution problems. Currently, the electrochemical technique has already been widely utilized for treatment of organic wastewater generated in various industrial processes such as dyeing, paper-making, textile, chemical engineering, tanning, biopharmaceutical engineering, etc. However, there is no documented literature on using electrocatalytic oxidation for treatment of resin desorption liquid.

To those who are skilled in the art, it is a lasting challenge how to realize removal of the highly concentrated organic pollutants in the desorption liquid and reuse of the highly concentrated regeneration agent in the desorption liquid simultaneously so that both the treatment cost and the amount of desorption liquid for final disposal can be significantly reduced.

### SUMMARY

### 1. Technical Problems to be Solved

In view of the fact that the ion exchange process will produce a small quantity of resin desorption liquid that is characterized by high salinity, high concentration, complex composition, high toxicity, poor biodegradability and high chromaticity, and unnecessary waste of resources and secondary pollution might happen if indiscreet disposal is taken to treat the resin desorption liquid, embodiments of the present invention provide a method for harmless disposal and resource utilization of resin desorption liquid, wherein the electrocatalytic oxidation is adopted to remove most of organic pollutants in the desorption liquid and to retain most of the regeneration agent simultaneously; after replenishing a certain amount of regeneration agent, the desorption liquid so treated presents excellent regenerability and can be reused again; the amount of desorption liquid for final disposal is therefore greatly reduced.

### 2. Technical Solution

A method for harmless disposal and resource utilization of resin desorption liquid generated in the ion exchange process, comprising the following steps:

(a) channel resin desorption liquid into an electrocatalytic oxidation device that consists of stabilized power supply, an electrolytic tank, an anode and a cathode; said electrolytic tank is divided by a cation-exchange membrane into a cathode chamber and an anode chamber, and said anode and cathode, both separately connected to the stabilized power supply, are located in the anode chamber and the cathode chamber respectively; said electrolytic tank is arranged with an inlet and an outlet; said cathode is made of graphite plate, titanium plate or titanium plate with a coating of ruthenium oxide or iridium oxide; said anode is a dimensionally stabilized titanium electrode with a coating of ruthenium oxide or iridium oxide;

(b) start the electrocatalytic oxidation process: keep the current density at said anode and cathode at 5˜50 mA/cm², the reaction time of resin desorption liquid in the electrolytic tank at 0.5˜3 h, the distance between said anode and cathode at 1.5˜5 cm; a direct oxidation reaction occurred at the anode surface whereby organic pollutants in the desorption liquid are decomposed through anodic electron transfer; besides, electrocatalytic oxidation process can generate ozone (O₃) and hydroxyl radicals (OH•) in the presence of water (H₂O), and can also generate firstly Cl₂ and then HClO and ClO⁻ using a large quantity of Cl⁻ available in the desorption liquid; O₃, OH•, Cl₂, HClO and ClO⁻ are all strong oxidants and can effectively decompose organic pollutants in the desorption liquid, namely, there exists an indirect oxidation reaction in the electrocatalytic oxidation process; in addition, during the electrocatalytic oxidation process, O₂ in the desorption liquid is reduced at the cathode surface into H₂O₂ firstly and then OH•, which can decompose some of organic pollutants in the desorption liquid as well; after the electrocatalytic oxidation process, the chromaticity of the desorption liquid is greatly reduced, and the level of UV₂₅₄, TOC and COD is also significantly decreased;

(c) add a certain amount of sodium chloride into the resin desorption liquid that has been treated by the electrocatalytic oxidation process; the mixture so obtained can be reused for regenerating the saturated ion exchange resin again, and its regeneration efficiency is 90·99% of that of fresh regeneration agent.

A certain amount mentioned in step (c) refers to the amount that can raise the percentage (by mass) of sodium chloride in the resin desorption liquid up to 12˜15%.

Preferably, in said step (a), the electrolytic tank is divided by a cation-exchange membrane from the middle into a cathode chamber and an anode chamber so that the oxidation effect can be improved due to the fact that the reduction reaction occurred at the cathode surface has the least interference upon the electrocatalytic oxidation process.

Preferably, in said step (b), the current density is adjusted to 20 mA/cm² while the reaction time is kept at 2 h.

Preferably, in said step (b), the pH value of the resin desorption liquid is adjusted to neutral or mild acidic before being treated by the electrocatalytic oxidation process.

Preferably, in said step (c), a certain amount of NaOH is also added into the treated resin desorption liquid.

### 3. Beneficial Effects

The following discloses a method for harmless disposal and resource utilization of resin desorption liquid generated in the ion exchange process. The electrocatalytic oxidation process mentioned in step (b) can reduce the level of COD, chromaticity and UV₂₅₄ in the desorption liquid by 30˜70%, 95˜97% and 50˜70% respectively; and it can raise the B/C ratio from 0.02 to 0.13˜0.20 and the median lethal concentration (LD₅₀) of the desorption liquid to Daphnia magna straus from 2% to 3%.

In comparison with conventional methods available in the prior art, this method is characterized by being convenient in operation, without addition of extra reagents or secondary pollution, and suitable for the desorption liquid with wide pH variations; it can effectively reduce the total cost of the process as it successfully realizes recycled utilization of resin desorption liquid by on the one hand avoiding unnecessary waste of regeneration agent and on the other hand reducing the amount of desorption liquid for final disposal. Therefore, this method can be widely used for harmless disposal of resin desorption liquid generated in the advanced treatment of wastewater using the resin ion exchange process.

### EMBODIMENTS

This is further illustrated by the following embodiments.

### Embodiment 1

Ion exchange resin is adopted for advanced treatment of the domestic sewage (from a Chinese city) that has undergone conventional biological treatment processes. When the resin adsorption reaches saturation, regenerate the resin with the regeneration agent (NaCl solution) for 30 min under normal temperature and pressure; the regeneration agent then turns into the desorption liquid after this regeneration process. The resin desorption liquid is then treated with an electrocatalytic oxidation device that consists of stabilized power supply, an electrolytic tank, an anode and a cathode; said electrolytic tank is arranged with an inlet and an outlet, and is divided by a cation-exchange membrane into a cathode chamber and an anode chamber; said anode and cathode are located in the anode chamber and the cathode chamber respectively; said cathode is made of graphite plate while said anode is a dimensionally stabilized titanium electrode with a coating of ruthenium oxide; channel the resin desorption liquid into the electrocatalytic oxidation device, keep the current density of the anode and cathode of the electrocatalytic oxidation device at 5 mA/cm², the distance between the anode and the cathode at 5 cm, the reaction time within the electrolytic tank at 0.5 h; the removal rate of COD, TOC, UV₂₅₄ and chromaticity reaches 42%, 26%, 55% and 95% respectively. The treated desorption liquid contains 12% (by mass) of NaCl, and can be directly reused as resin regeneration agent without replenishment of NaCl; its efficiency in regenerating saturated resin reaches 90% of that of fresh regeneration agent; after 3 times of reuse, it is subjected to final disposal as its regeneration efficiency drops down to less than 60% of that of the fresh regeneration agent. When being treated by the method disclosed herein, the amount of desorption liquid subjected to final disposal is only ¼ of that treated by other conventional methods.

### Embodiment 2

Ion exchange resin is adopted for advanced treatment of the domestic sewage (from a Chinese city) that has undergone conventional biological treatment processes. When the resin adsorption reaches saturation, regenerate the resin with the regeneration agent (NaCl solution) for 30 min under normal temperature and pressure; the regeneration agent then turns into the desorption liquid after this regeneration process. The resin desorption liquid is then treated with an electrocatalytic oxidation device; the device used herein is the same with that used in embodiment 1, with exceptions as follows: said cathode is made of titanium plate while said anode is a dimensionally stabilized titanium electrode with a coating of iridium oxide; keep the current density at 20 mA/cm², the anode-cathode distance at 4 cm, the reaction time at 2 h; the removal rate of COD, TOC, UV₂₅₄ and chromaticity reaches 51%, 29%, 58% and 97% respectively. The treated desorption liquid contains 11% (by mass) of NaCl, and can be reused as resin regeneration agent after replenishment of NaCl and raising the NaCl concentration therein to 12% (by mass); its efficiency in regenerating saturated resin reaches 92% of that of fresh regeneration agent; after 4 times of reuse, it is subjected to final disposal as its regeneration efficiency drops down to less than 60% of that of the fresh regeneration agent. When being treated by the method disclosed herein, the amount of desorption liquid subjected to final disposal is only ⅕ of that treated by other conventional methods.

### Embodiment 3

Ion exchange resin is adopted for advanced treatment of the domestic sewage (from a Chinese city) that has undergone conventional biological treatment processes. When the resin adsorption reaches saturation, regenerate the resin with the regeneration agent for 30 min under normal temperature and pressure; the regeneration agent then turns into the desorption liquid after this regeneration process. The resin desorption liquid is then treated with an electrocatalytic oxidation device; the device used herein is the same with that used in embodiment 1, with exceptions as follows: said cathode is made of titanium plate with a coating of ruthenium oxide while said anode is a dimensionally stabilized titanium electrode with a coating of iridium oxide; keep the current density at 30 mA/cm², the anode-cathode distance at 3 cm, the reaction time at 2 h; the removal rate of COD, TOC, UV₂₅₄ and chromaticity reaches 54%, 34%, 62% and 97% respectively. The treated desorption liquid contains 11% (by mass) of NaCl, and can be reused as resin regeneration agent after replenishment of NaCl and raising the NaCl concentration therein to 12% (by mass); its efficiency in regenerating saturated resin reaches 94% of that of fresh regeneration agent; after 5 times of reuse, it is subjected to final disposal as its regeneration efficiency drops down to less than 60% of that of the fresh regeneration agent. When being treated by the method disclosed herein, the amount of desorption liquid subjected to final disposal is only ⅙ of that treated by other conventional methods.

### Embodiment 4

Ion exchange resin is adopted for advanced treatment of the domestic sewage (from a Chinese city) that has undergone conventional biological treatment processes. When the resin adsorption reaches saturation, regenerate the resin with the regeneration agent for 30 min under normal temperature and pressure; the regeneration agent then turns into the desorption liquid after this regeneration process. The resin desorption liquid is then treated with an electrocatalytic oxidation device; the device used herein is the same with that used in embodiment 1, with exceptions as follows: said cathode is made of titanium plate with a coating of iridium oxide while said anode is a dimensionally stabilized titanium electrode with a coating of iridium oxide; keep the current density at 40 mA/cm², the anode-cathode distance at 2 cm, the reaction time at 2 h; the removal rate of COD, TOC, UV₂₅₄ and chromaticity reaches 62%, 40%, 68% and 99% respectively. The treated desorption liquid contains 10% (by mass) of NaCl, and can be reused as resin regeneration agent after replenishment of NaCl and raising the NaCl concentration therein to 14% (by mass); its efficiency in regenerating saturated resin reaches 95% of that of fresh regeneration agent; after 6 times of reuse, it is subjected to final disposal as its regeneration efficiency drops down to less than 60% of that of the fresh regeneration agent. When being treated by the method disclosed herein, the amount of desorption liquid subjected to final disposal is only 1/7 of that treated by other conventional methods.

### Embodiment 5

Ion exchange resin is adopted for advanced treatment of the domestic sewage (from a Chinese city) that has undergone conventional biological treatment processes. When the resin adsorption reaches saturation, regenerate the resin with the regeneration agent for 30 min under normal temperature and pressure; the regeneration agent then turns into the desorption liquid after this regeneration process. The resin desorption liquid is then treated with an electrocatalytic oxidation device; the device used herein is the same with that used in embodiment 1, with exceptions as follows: said cathode is made of graphite plate while said anode is a dimensionally stabilized titanium electrode with a coating of ruthenium oxide; keep the current density at 50 mA/cm², the anode-cathode distance at 1.5 cm, the reaction time at 2 h; the removal rate of COD, TOC, UV₂₅₄UV₂₅₄ and chromaticity reaches 64%, 42%, 70% and 99% respectively. The treated desorption liquid contains 9% (by mass) of NaCl, and can be reused as resin regeneration agent after replenishment of NaCl and raising the NaCl concentration therein to 12% (by mass); its efficiency in regenerating saturated resin reaches 96% of that of fresh regeneration agent; after 6 times of reuse, it is subjected to final disposal as its regeneration efficiency drops down to less than 60% of that of the fresh regeneration agent. When being treated by the method disclosed herein, the amount of desorption liquid subjected to final disposal is only 1/7 of that treated by other conventional methods.

### Embodiment 6

The resin desorption liquid is treated with an electrocatalytic oxidation device; the device and the operation parameters used herein are the same with those used in embodiment 5; the removal rate of COD, TOC, UV₂₅₄ and chromaticity reaches 64%, 42%, 70% and 99% respectively. The treated desorption liquid contains 9% (by mass) of NaCl, and can be reused as resin regeneration agent after replenishment of NaCl and raising the NaCl concentration therein to 14% (by mass); its efficiency in regenerating saturated resin reaches 98% of that of fresh regeneration agent; after 7 times of reuse, it is subjected to final disposal as its regeneration efficiency drops down to less than 60% of that of the fresh regeneration agent. When being treated by the method disclosed herein, the amount of desorption liquid subjected to final disposal is only ⅛ of that treated by other conventional methods.

### Embodiment 7

The resin desorption liquid is treated with an electrocatalytic oxidation device; the device and the operation parameters used herein are the same with those used in embodiment 5; the removal rate of COD, TOC, UV₂₅₄ and chromaticity reaches 64%, 42%, 70% and 99% respectively. The treated desorption liquid contains 9% (by mass) of NaCl, and can be reused as resin regeneration agent after adding new NaCl and NaOH and raising the concentration of NaCl and NaOH therein to 15% and 0.5% (by mass) respectively; its efficiency in regenerating saturated resin reaches 99% of that of fresh regeneration agent; after 7 times of reuse, it is subjected to final disposal as its regeneration efficiency drops down to less than 60% of that of the fresh regeneration agent. When being treated by the method disclosed herein, the amount of desorption liquid subjected to final disposal is only ⅛ of that treated by other conventional methods.

### Embodiment 8

Ion exchange resin is adopted for advanced treatment of dyeing wastewater that has undergone conventional biological treatment processes. When the resin adsorption reaches saturation, regenerate the resin with the regeneration agent for 30 min under normal temperature and pressure; the regeneration agent then turns into the desorption liquid after this regeneration process. The resin desorption liquid is then treated with an electrocatalytic oxidation device that consists of stabilized power supply, an electrolytic tank, an anode and a cathode; said electrolytic tank is arranged with an inlet and an outlet, and is divided by a cation-exchange membrane from the middle into a cathode chamber and an anode chamber; said anode and cathode are located in the anode chamber and the cathode chamber respectively; said cathode is made of graphite plate while said anode is a dimensionally stabilized titanium electrode with a coating of ruthenium oxide; channel the resin desorption liquid into the electrocatalytic oxidation device, keep the current density of the anode and cathode of the electrocatalytic oxidation device at 20 mA/cm², the distance between the anode and the cathode at 2 cm, the reaction time within the electrolytic tank at 3 h; the removal rate of COD, TOC, UV₂₅₄ and chromaticity reaches 60%, 39%, 66% and 97% respectively. The treated desorption liquid contains 9% (by mass) of NaCl, and can be reused as resin regeneration agent after replenishment of NaCl and raising the NaCl concentration therein to 12% (by mass); its efficiency in regenerating saturated resin reaches 94% of that of fresh regeneration agent; after 4 times of reuse, it is subjected to final disposal as its regeneration efficiency drops down to less than 60% of that of the fresh regeneration agent. When being treated by the method disclosed herein, the amount of desorption liquid subjected to final disposal is only ⅕ of that treated by other conventional methods.

### Embodiment 9

The resin desorption liquid is treated with an electrocatalytic oxidation device; the device and the operation parameters used herein are the same with those used in embodiment 8; the removal rate of COD, TOC, UV₂₅₄ and chromaticity reaches 60%, 39%, 66% and 97% respectively. The treated desorption liquid contains 9% (by mass) of NaCl, and can be reused as resin regeneration agent after replenishment of NaCl and raising the NaCl concentration therein to 15% (by mass); its efficiency in regenerating saturated resin reaches 98% of that of fresh regeneration agent; after 5 times of reuse, it is subjected to final disposal as its regeneration efficiency drops down to less than 60% of that of the fresh regeneration agent. When being treated by the method disclosed herein, the amount of desorption liquid subjected to final disposal is only ⅙ of that treated by other conventional methods.

### Embodiment 10

The resin desorption liquid is treated with an electrocatalytic oxidation device; the device and the operation parameters used herein are the same with those used in embodiment 8; the removal rate of COD, TOC, UV₂₅₄ and chromaticity reaches 60%, 39%, 66% and 97% respectively. The treated desorption liquid contains 9% (by mass) of NaCl, and can be reused as resin regeneration agent after adding new NaCl and NaOH and raising the concentration of NaCl and NaOH therein to 15% and 0.5% (by mass) respectively; its efficiency in regenerating saturated resin reaches 99% of that of fresh regeneration agent; after 5 times of reuse, it is subjected to final disposal as its regeneration efficiency drops down to less than 60% of that of the fresh regeneration agent. When being treated by the method disclosed herein, the amount of desorption liquid subjected to final disposal is only ⅙ of that treated by other conventional methods.

1. A method for harmless disposal and resource utilization of resin desorption liquid generated in the ion exchange process, comprising the following steps:
(a) Channelling resin desorption liquid into an electrocatalytic oxidation device; said electrocatalytic oxidation device includes a stabilized power supply, an electrolytic tank, an anode and a cathode; said electrolytic tank is arranged with an inlet and an outlet; said cathode is made of graphite plate, titanium plate or titanium plate with a coating of ruthenium oxide or iridium oxide; said anode is a dimensionally stabilized titanium electrode with a coating of ruthenium oxide or iridium oxide; and
(b) starting the electrocatalytic oxidation process: keeping the current density at said anode and cathode at 5˜50 mA/cm², the reaction time of resin desorption liquid in the electrolytic tank at 0.5˜3 h, the distance between said anode and cathode at 1.5˜5 cm.

2. The method for harmless disposal and resource utilization of resin desorption liquid generated in the ion exchange process as defined in claim 1, wherein the method also includes step (c): sodium chloride (NaCl) is replenished into the resin desorption liquid that has been treated by the electrocatalytic oxidation process; the mixture so obtained can be reused for regenerating saturated ion exchange resin; the replenished amount of sodium chloride accounts for 12˜15% (by mass) of the mixture (renewed resin regeneration agent).

3. The method for harmless disposal and resource utilization of resin desorption liquid generated in the ion exchange process as defined in claim 1, wherein in said step (a), the electrolytic tank is divided by a cation-exchange membrane from a middle into a cathode chamber and an anode chamber, and said anode and cathode are respectively located in the anode chamber and the cathode chamber respectively.

4. The method for harmless disposal and resource utilization of resin desorption liquid generated in the ion exchange process as defined in claim 1, wherein in said step (b), the current density is adjusted to 20 mA/cm² while the reaction time is kept at 2 h.

5. The method for harmless disposal and resource utilization of resin desorption liquid generated in the ion exchange process as defined in claim 2, wherein in said step (c), NaOH is also added into the treated resin desorption liquid.
